(19) United States
(12) Patent Application Publication
(10) Pub. No.: US 2002/0114597 A1
(43) Pub. Date: Aug. 22, 2002

(54) Method and apparatus for reducing dispersion slope in optical transmission fibre systems

(75) Inventors: Robert K. Brimacombe, Ottawa (CA); David R. Walker, Ottawa (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 09/745,410

(22) Filed: Dec. 26, 2000

(51) Int. Cl. G02B 6/16

(52) U.S. Cl. 385/123

(57) ABSTRACT

Some optical transmission fibers, such as LEAF and EFEAF, have a positive dispersion slope too great to be fully compensated for by a dispersion compensation fiber (DCF). To achieve improved dispersion compensation for such transmission fibers, the signals may be passed through a non-dispersion shifted fiber (NDSF) as well as through a DCF.

### FIELD OF THE INVENTION

The present invention relates in general to optical transmission fibers, and more specifically, to a method and apparatus for reducing dispersion slope (wavelength dependent dispersion) in optical transmission fiber systems.

### BACKGROUND OF THE INVENTION

A communications system may employ an optical transmission fiber to transmit digital or analogue information. In such case, the information is typically sent along the fiber as light pulses. In order to accommodate several different channels on one fiber, the light pulses for each channel have a different nominal frequency (or wavelength). However, a train of optical pulses associated with a single channel is not in fact composed of a single optical frequency but a spectrum of frequencies extending over a frequency band. The bandwidth associated with these optical frequencies of a channel is usually directly related to the data rate associated with that channel: where channels have high data rates (e.g., 1000 GHz), the bandwidth is large (e.g., 1000 GHz—in which case there will be at least a 1000 GHz.spacing between channels to avoid overlap). Different wavelengths of light propagate along an optical transmission fiber at different speeds: this property is known as chromatic dispersion (CD). If an optical pulse has a large bandwidth (i.e., it is composed of a large number of optical frequencies) the CD causes the pulse to change its temporal profile. The change in temporal profile associated with the CD may result in reduced system performance limiting the distance that the information may be propagated without electronic regeneration. For this reason it can be important to control the CD of the optical system for the wavelengths associated with a single optical channel.

If there is only a single optical channel on an optical fiber, it is possible to sufficiently control the total CD by employing dispersion compensation components, which are often comprised of Dispersion Compensating Fiber (DCF). It is then possible to employ a combination of transmission fibers and DCF such that the total cumulative CD at the central wavelength of interest is maintained at the required value.

The properties of the optical fiber often result in a wavelength dependant CD which means that for different optical channels the total CD is a function of wavelength. This rate of change of CD as a function of wavelength is commonly called dispersion slope. In Dense Wavelength Division Multiplexed (DWDM) systems employing many different optical channels not only must the CD be managed but also the dispersion slope must be compensated by the DCF to ensure that all wavelengths experience the same total CD. For optimal performance the total CD (for the whole optical system) of all wavelengths propagated down a single optical fiber must be maintained at a constant value (not necessarily 0 ps/nm). Failure to do so results in optical pulses in some channels spreading due to dispersive effects as previously explained. Dispersion slope is a particular problem for optical channels in the commonly used C band (1.530 μm to 1.562 μm) and L band (1.570 μm to 1.602 μm) of the Erbium Doped Fiber Amplifier (EDFA).

Current popular optical transmission fibers employ technologies called ‘dispersion shifting’ which essentially reduce the CD for the optical wavelengths in the C-band and L-band but result in a high Relative Dispersion Slope (RDS). RDS is defined as the dispersion slope divided by the dispersion value at a given wavelength. Current manufacturing technologies associated with DCF may not allow the RDS of the DCF to be equal and opposite of that characteristic of the transmission fiber. The result is that when commercially available DCF is used to CD compensate some transmission fibers, the CD experienced by many channels in the DWDM system is not maintained at the correct optimal value. This can result in poor performance and high Bit Error Ratio (BER) for some optical channels. This in turn limits the total capacity or reach of the optical system.

For example, a common transmission fiber manufactured by Coming Inc. called Large Effective Area Fiber (LEAF™) may have a CD value of around 1.5 ps/nm/km at 1500 nm but a CD value of around 8 ps/nm/km at 1600 nm resulting in an RDS of approximately ((8-1.5)/100/1.5=) 0.043 nm⁻¹ at 1500 nm. As a second example, a common transmission fiber manufactured by Lucent Inc. called TrueWave™ Reduced Slope (TWRS) may have a CD value of around 2.1 ps/nm/km at 1500 nm but a CD value of around 6.6 ps/nm/km at 1600 nm resulting in an RDS of approximately 0.021 nm⁻¹ at 1500 nm. Thus, a graph of the CD value of a fiber versus wavelength yields a sloped line. For LEAF™ or TrueWave™ fiber, the slope is positive. For a DCF, the slope is negative. However, in order for a DCF to fully compensate for dispersion in LEAF™ or TrueWave™ fiber at all wavelengths, the net RDS of the transmission fiber plus DCF should be minimised (ideally 0). In reality, it is not possible to fabricate a DCF so as to have such a negative slope. Thus, known dispersion compensation systems for LEAF™ and TrueWave™ fibers which use DCF only partially compensate for dispersion effects for all channels.

Another approach to compensate for dispersion is to introduce a dispersion compensation system for each channel (frequency) of an optical transmission system. However, this approach is expensive.

Therefore, there is a need for a cost effective manner of more fully compensating for RDS in certain optical transmission systems.

### SUMMARY OF THE INVENTION

The present invention is directed at a method and apparatus for facilitating the reduction of RDS in transmission fiber systems which have relatively steep positive RDS. The invention involves passing signals on the transmission line through an optical fiber with a positive dispersion but relatively small (or negative) RDS so that a reduced RDS is imparted to the signals. It is then easier to compensate for the residual RDS.

According to an aspect of the present invention, there is provided a method for facilitating the reduction of relative dispersion slope (“RDS”) in an optical transmission fiber having a relatively steep RDS, comprising: passing signals on said optical transmission fiber through a second optical fiber having a less steep RDS.

In another aspect of the present invention, there is provided apparatus for facilitating the reduction of relative dispersion slope (“RDS”) in an optical transmission fiber having a relatively steep RDS, comprising: a dispersion compensation module (DCM) comprising a second optical fiber having a a less steep RDS.

Other aspects and features of the present invention will become apparent to those ordinarily skilled in the art upon review of the following description of specific embodiments of the invention in conjunction with the accompanying drawings.

### BRIEF DESCRIPTION OF THE DRAWINGS

In the figures, which illustrate, by example only, an embodiment of the invention,

FIG. 1 is a schematic diagram of a link in an optical communication system;

FIG. 2 is a schematic diagram of a known amplifier site which may be used in the link of FIG. 1,

FIG. 3 is a graph of dispersion versus wavelength for a link using known amplifier sites,

FIG. 4 is a graph of RDS versus wavelength for the link of FIG. 3,

FIG. 5 is a schematic diagram of an amplifier site made in accordance with this invention,

FIG. 6 is a more detailed schematic diagram of the amplifier site of FIG. 5,

FIG. 7 is a graph of dispersion versus wavelength for portions of a link using amplifier sites constructed in accordance with this invention,

FIG. 8 is is a graph of RDS versus wavelength for portions of a link using amplifier sites constructed in accordance with this invention,

FIG. 9 is is a graph of dispersion versus wavelength for a link using amplifier sites constructed in accordance with this invention, and

FIG. 10 is is a graph of RDS versus wavelength for a link using amplifier sites constructed in accordance with this invention.

### DETAILED DESCRIPTION

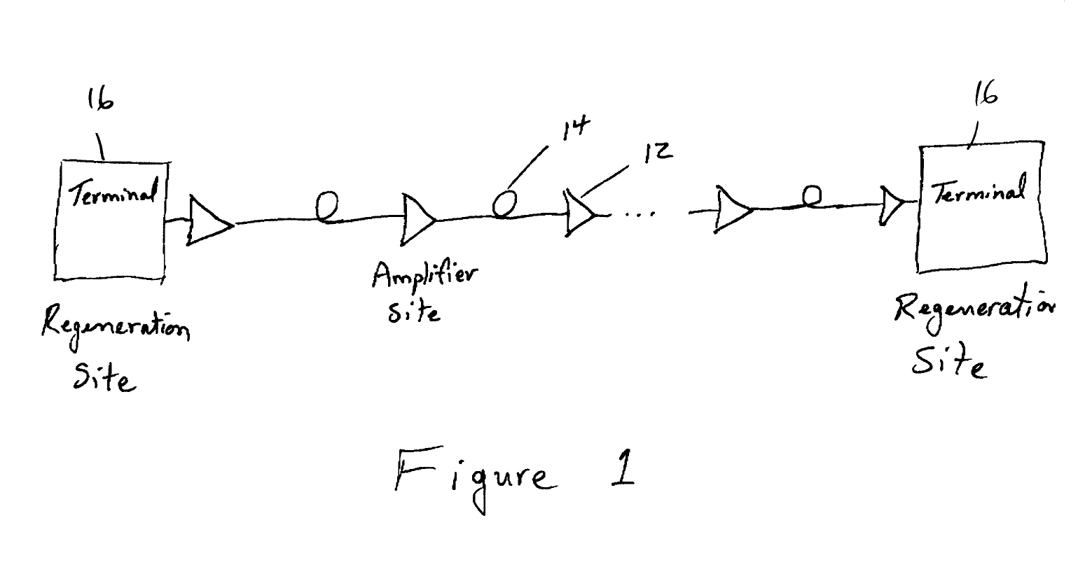

Turning to FIG. 1, a typical communication link (or system) includes optical amplifier sites 12 interposed in optical transmission fiber 14. The signals experience energy loss during transmission over the fiber. The optical amplifier sites act to increase the signal power so that the signals may be transmitted through the next span of optical fiber. The distance between optical amplifier sites is typically between 60 to 100 km. The number of amplified spans may be up to six or more and is ultimately limited by noise and distortion accumulation, which degrades the signal. At the end of the amplified spans, electrical regeneration is required at regeneration sites 16. However, these sites add cost to the system. The subject invention helps to reduce the accumulation of signal distortion by improving the compensation for chromatic dispersion in the link, thereby increasing the system reach between regeneration sites 16 and reducing system cost.

As the signals propagate through the fiber, they experience chromatic dispersion (CD). The chromatic dispersion of an optical medium causes the propagation speed of the light signals to be dependent on the wavelength of the signals. The variation in dispersion with wavelength is referred to as dispersion slope. This has two implications for fiber optic systems.

First, a light signal (i.e., a channel) is never truly composed of a single wavelength, so different parts of a given signal may propagate at different speeds, resulting in signal distortion. To minimize distortion in the signal, all wavelengths making up the signal should ideally experience the same net dispersion.

Second, systems of interest today are Dense Wavelength Division Multiplexed (DWDM) systems, meaning that there are many signals at different wavelengths propagating in the same fiber. Therefore, performance is optimized when all wavelengths of all signals experience the same net dispersion when they propagate through the link.

Dispersion slope compensation is used to achieve a more uniform net dispersion for all wavelengths. The subject invention improves the dispersion slope compensation.

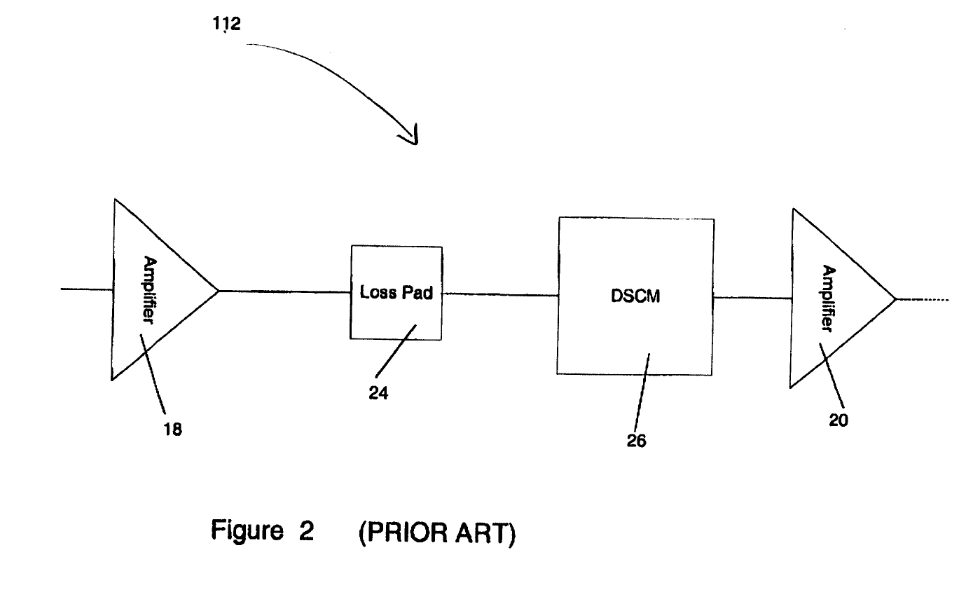

Turning to FIG. 2, a known amplifier site 112 includes first and second amplifiers 18 and 20, respectively. The amplifiers 18 and 20 of an amplifier site 112 are typically erbium doped fiber amplifiers (EDFA). These amplifiers typically introduce more gain than is required to compensate for attenuation of the signals between amplifier sites so that there is excess gain to allow for other energy consuming signal processes. The site has a dispersion slope compensation module (DSCM) 26 manufactured from dispersion compensating fiber (DCF). The size of the DSCM is chosen to provide the optimum (i.e., not necessarily zero) net dispersion at the center of the band (e.g., C band); the net dispersion at the edges of the band is determined by the dispersion slope of the transmission fiber and the DSCM. The site 112 further may include a loss pad 24, manufactured from absorbent glass. The loss pad 24 is present merely to absorb unused excess gain imparted by the first amplifier 18, thus its size (and hence its level of absorption) is chosen after it is known what signal energy will be absorbed by other components at the amplifier site 112. Note that the transmission path between amplifiers 18 and 20 at amplifier sites 112 is known as a mid stage access (MSA) site.

Transmission fiber and DCF can both be characterized by their relative dispersion slope (RDS), which, as aforenoted, is defined as the quotient of dispersion slope over dispersion value. Thus, the RDS value for a fiber at a given wavelength is the dispersion slope at that wavelength divided by the dispersion value at that wavelength. In general, DCF with a high RDS is difficult to manufacture. Therefore, currently available DCF has a moderate RDS. This results in good slope compensation of moderate to low RDS transmission fiber (such as non-dispersion shifter fiber (NDSF)—also known as standard fiber or single mode fiber (SMF)), but poor slope compensation of high RDS fiber types (such as LEAF and TrueWave). The subject invention enables more effective slope compensation of high RDS transmission fiber types.

Typical line amplifier sites are designed to accommodate the highest loss DSCMs that might ever be deployed in the system, which is typically 10 to 12 dB loss per line amp site. In particular, a system using NDSF as the transmission fiber requires the highest loss DSCMs. This is because NDSF has the highest dispersion per km of any fiber type in the wavelength region of interest, 1550 nm. The DSCMs designed for NDSF have the highest insertion loss because they use the longest lengths of DCF to compensate for the high dispersion of the fiber. Fortunately, the RDS of NDSF is relatively low and so DSCMs are commercially available which provide good dispersion slope compensation for NDSF transmission fiber.

For fiber types such as LEAF and TrueWave, the dispersion is much lower than NDSF and so the DSCMs required to compensate the dispersion use relatively short lengths of DCF and have much lower insertion loss. Therefore, in such systems a loss pad is usually required in the amplifier site to take up the excess gain. However, the RDS of LEAF and TrueWave are relatively high, LEAF being the highest, and so the DSCMs commercially available do not provide adequate dispersion slope compensation.

The subject invention takes advantage of the available loss budget at the line amplifier sites to increase the net RDS of the dispersion compensation at the line amplifier site and thus more closely match it to the RDS of the transmission fiber. This is achieved by adding low RDS fiber possessing positive dispersion, such as NDSF, at the line amplifier site. The combination of NDSF and DCF has a higher RDS than DCF alone and thus provides improved slope compensation for the link.

Two examples follow to illustrate the improvement that occurs by implementing the subject invention. Both examples employ a 600 km link configured in accordance with FIG. 1 which comprises six 100 km spans. Such a link has seven mid stage access (MSA) sites: one at either end and one between each pair of spans. There is an MSA site present at each amplifier site. The transmission fiber is TrueWave Reduced Slope (TWRS) fiber.

In the first example, known amplifier sites 112 shown in FIG. 2 are employed at each MSA. Optimal dispersion slope compensation may be accomplished with DSCMs at only two of the amplifier sites 112. The DSCMs are manufactured using DCF having the highest RDS currently commercially available, i.e. the best DCF for this application. Each of the two DSCMs has a 9 dB insertion loss. The line amplifier sites at the five remaining mid stage access (MSA) sites simply have loss pads installed. Table 1 gives dispersion values for such a link. Dispersion values are given for the edges and the (approximate) center of the C band. Also given is the dispersion of the DSCMs.

TABLE 1
Known system

| | TWRS Fibre | DSCM (DCF) | Net |
|---|---|---|---|
| Wavelength | dispersion over the | dispersion over the | dispersion of |
| (nm) | link (ps/nm) | link (ps/nm) | link (ps/nm) |
| 1530 | 2141 | −1502 | 639 |
| 1545 | 2553 | −1674 | 879 |
| 1562 | 3006 | −1869 | 1137 |

| | |
|---|---|
| Dispersion difference over band (dispersion window) = | 498 |

It is noted that the five MSA sites with loss pads are available to add additional dispersion compensating devices to implement the subject invention.

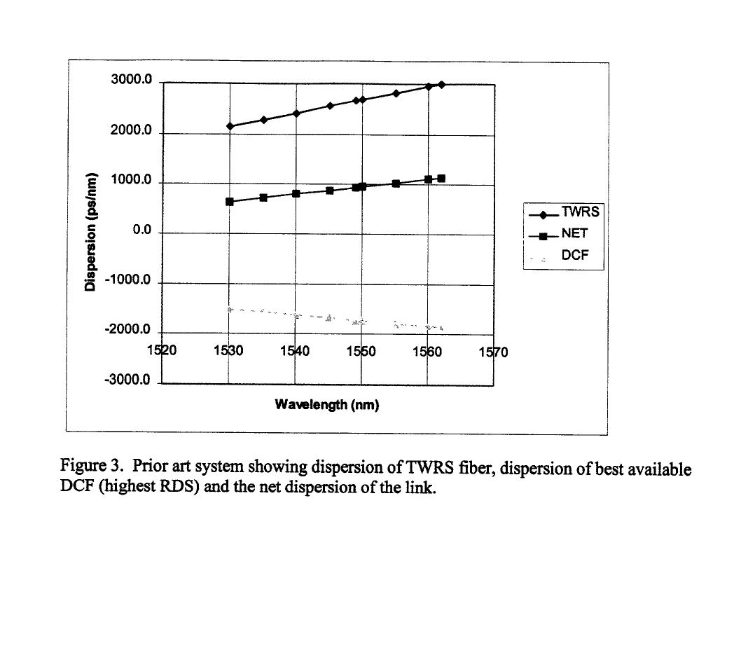

The dispersion characteristics of the first example are examined. FIG. 3 shows the dispersion of signals on TWRS transmission fiber 14 as a function of wavelength and the dispersion of signals on the DCF in the DSCM 26 as a function of wavelength. It will be noted that the dispersion values in the transmission fiber 14 are positive and that the dispersion slope in the transmission fiber is also positive. In contrast, the dispersion values in the DCF of the DSCM 26 are negative and the dispersion slope in the DCF is negative. Consequently, while signals transmitted over the transmission fiber 14 are subject of a positive dispersion (with dispersion values which are increasingly higher for increasingly longer wavelengths), these same signals are subject of a negative dispersion (with dispersion values which are progressively lower for increasingly longer wavelengths) as they propagate through the DSCM 26 of the amplifier site 112.

The variation in system net dispersion over the wavelength band, identified as the dispersion window in Table 1 or evident as the net dispersion slope in FIG. 3, is an indicator of system performance. A zero net dispersion slope for the system is ideal, whereas a high dispersion slope for the link results in a large dispersion window over which the terminal equipment (transmitters, receivers) must operate. As the dispersion window increases, the terminal equipment must operate farther from the optimum net dispersion, and therefore the performance of the link degrades.

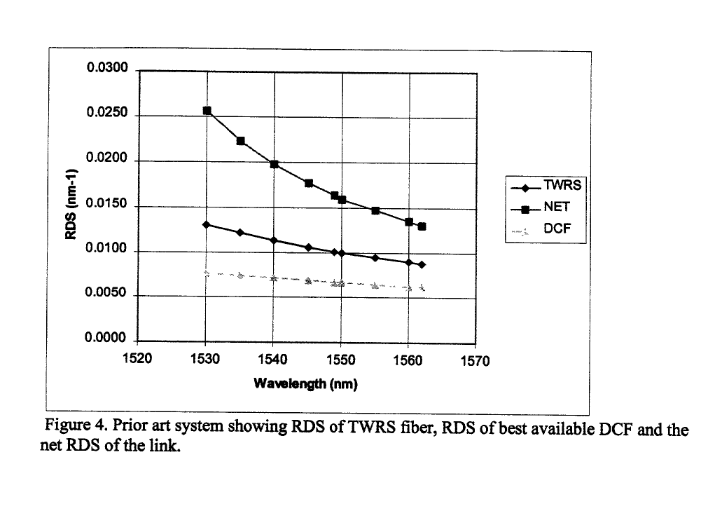

FIG. 4 shows the RDS versus wavelength of the first example. As can be seen in FIG. 4, the RDS in the transmission fiber 14 is higher than the RDS in the DCF. Under such conditions, the DCF will not cancel the dispersion imparted by the transmission fiber for all frequencies. However, it has not been possible to fabricate a DCF with a sufficiently high RDS to provide adequate slope compensation for TWRS fiber in the C band. Therefore, full slope compensation has not been possible with known amplification sites 112.

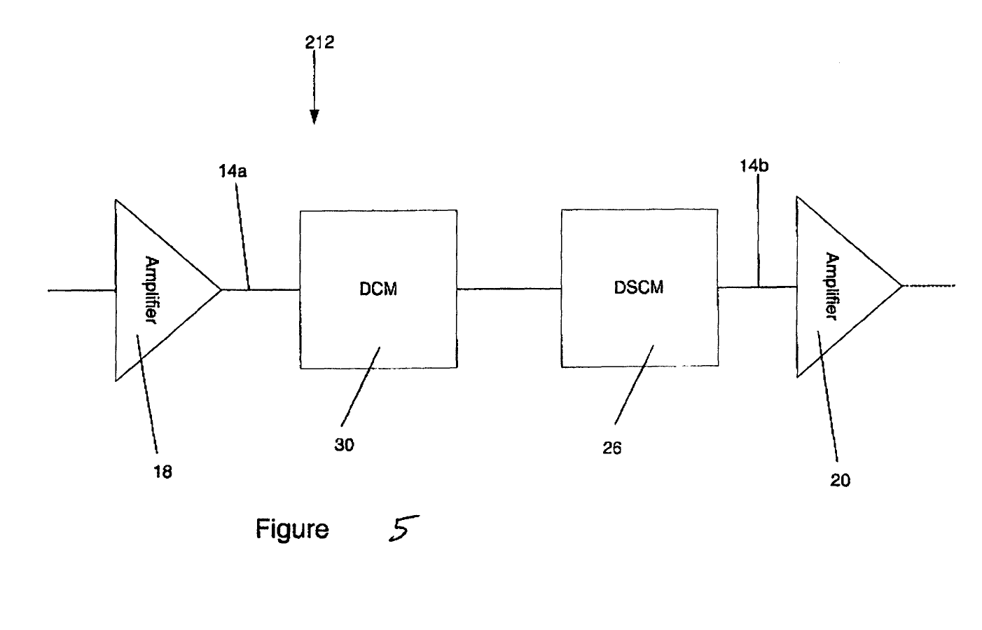

In the second example, the link (i.e., TWRS transmission fiber, with six spans of 100 km per span) may be adapted to the subject invention by the use of amplifier sites 212 shown in FIG. 5. Turning to FIG. 5, the DSCM employs the same type of DCF as used in the first example, but in greater quantity. The over-compensation of the link by DCF is then corrected by adding NDSF to the link at the MSA sites.

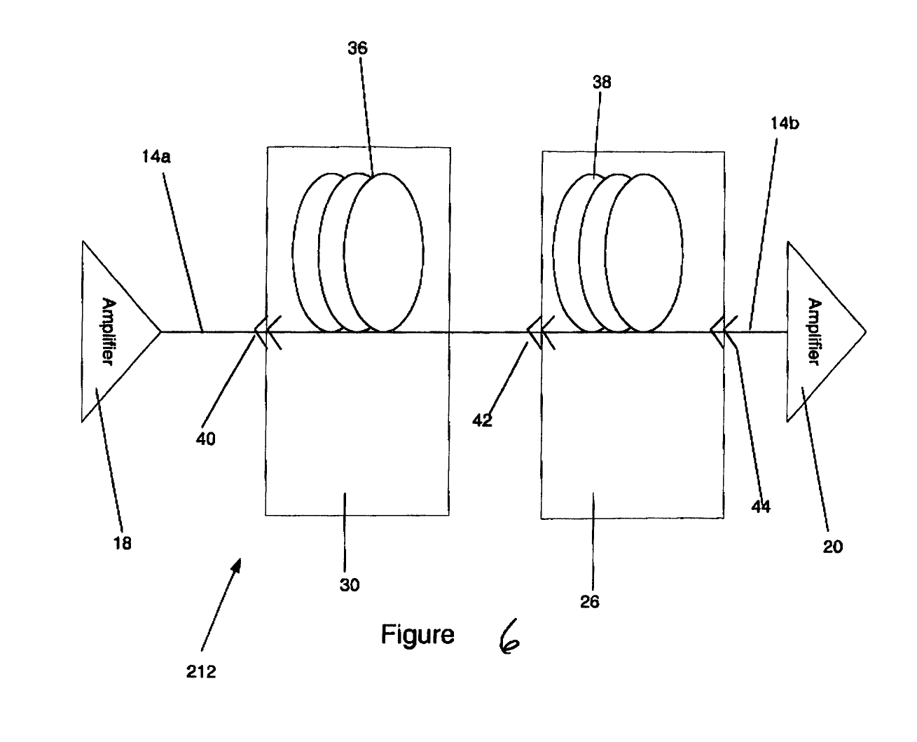

FIG. 6 shows a more detailed schematic of a portion of the amplifier site 212. From FIG. 6 it will be apparent that the dispersion compensation module (DCM) 30 is a loop of non-dispersion shifted fiber (NDSF) 36 wound on a spool which is connected at a first end with the incoming transmission fiber 14a via suitable connectors or hook-ups 40. NDSF is a widely used fiber for transmission line purposes. The second end of the NDSF spool 36 is connected (via suitable connectors or hook-ups 42) to a first end of a loop of DCF 38 which is wound on a spool. The spool-wound DCF comprises the DSCM 26. The opposite end of the spool of DCF 38 is then connected to the outgoing transmission fiber 14b (via connectors 44). It will be understood that, in consequence, the DCM 30 and the DSCM 32 are interposed between the incoming and outgoing transmission fiber sections 14a and 14b.

The combination of the DCM and the DSCM at the amplifier sites can be thought of as a compound DSCM composed of two fiber types, NDSF and DCF, as described above and shown in FIG. 6. Note that the effect is the same if some amplifier sites contain only DCF and others contain only NDSF, as long as the total amounts of each fiber type are kept in the correct proportion. In fact, it may be advantageous from an MSA loss budget perspective to do so.

The dispersion characteristics of the exemplary link of the second example, which link is designed according to the subject invention, are given in Table 2.

TABLE 2
System design according to subject invention.

| | TWRS Fibre | | | Net |
|---|---|---|---|---|
| | dispersion | DSCM (DSF) | DCM (NDSF) | dispersion |
| Wavelength | over | Dispersion | dispersion | of link |
| (nm) | link (ps/nm) | (ps/nm) | (ps/nm) | (ps/nm) |
| 1530 | 2141 | −3381 | 1982 | 742 |
| 1545 | 2553 | −3768 | 2093 | 879 |
| 1562 | 3006 | −4206 | 2215 | 1015 |

| | |
|---|---|
| Dispersion difference over band (dispersion window) = | 273 |

In implementing this invention, all seven MSA sites are used. Four sites contain DSCMs (containing DCF) with insertion loss of 9 dB each per site. Three sites contain DCMs (containing NDSF) in modules having insertion loss of 11 dB per site. Note from Table 2 that the dispersion window is reduced by this invention from the 498 ps/nm of the first example (see Table 1) to 273 ps/nm. The significance of this is that the terminal equipment (transmitters and receivers) at each end of the link will function closer to their optimum performance, which depends on the net dispersion of the link. If the variation of dispersion across the wavelength band is reduced, as it is with the present invention, then all terminal equipment will experience a net dispersion closer to the optimum value than is possible with prior systems.

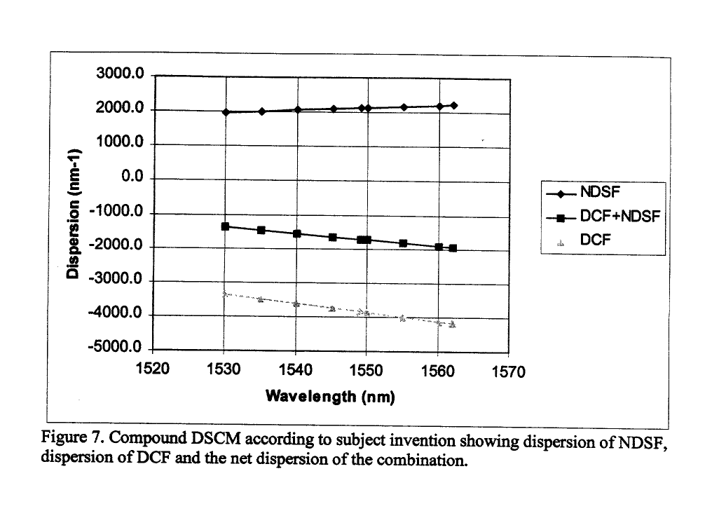

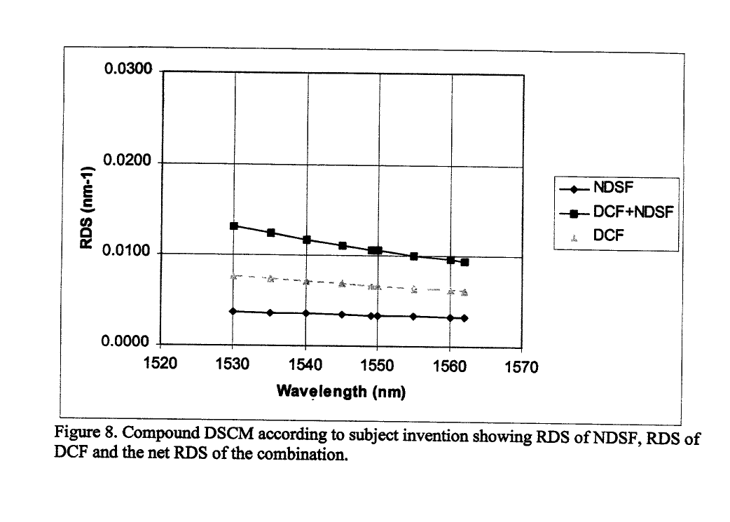

FIGS. 7 and 8 show the total dispersion (FIG. 7) and RDS (FIG. 8) for the link resulting from each compensating fiber type and, as well, the compound effect of the compensating fibers. The cumulative values, resulting from all of the MSAs, are shown. Note that the RDS of the combined DCF and NDSF is much greater than the RDS of the constituents alone. The resultant high RDS is better suited to provide dispersion slope compensation for the high RDS TWRS transmission fiber.

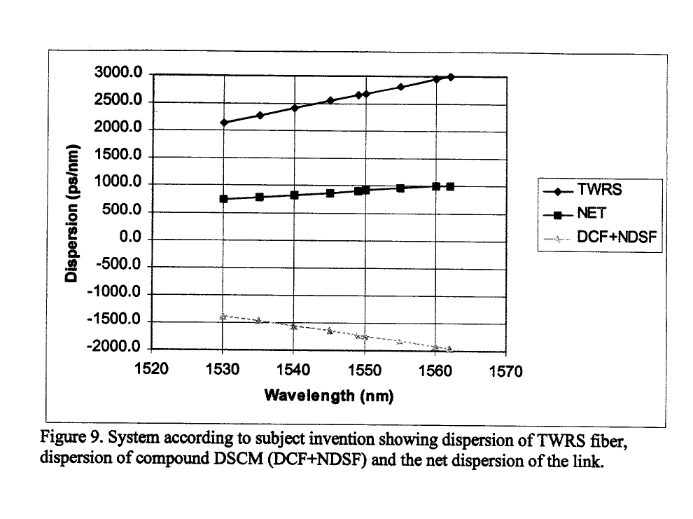

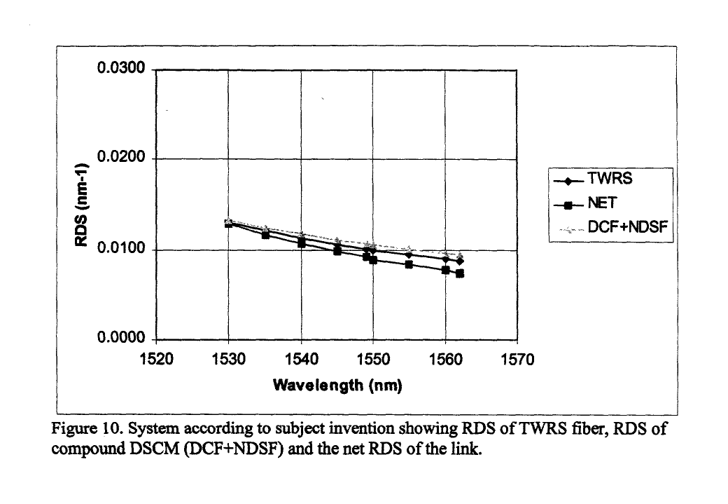

The effect of the DCF and NDSF on the system (i.e., the link) dispersion and RDS is shown by FIGS. 9 and 10. Note from FIG. 10 that the net RDS of the second example, which employs the amplifier sites of FIG. 5, is substantially lower than the net RDS of the first example, which employs the amplifier sites of FIG. 2 (i.e., compare with FIG. 4). The exact difference in RDS is obtained by comparing at a wavelength of 1545 nm, at which point the net dispersion is the same for each system. The ideal net dispersion slope of a system would be zero, and thus the RDS would be zero, since then all signal wavelengths would experience the same net dispersion and all terminal equipment would be operating at the optimum point.

In both examples described above, the net dispersion of the link is designed to be positive. This dispersion design is typical of many fiber optic systems. In such a design, the RDS of the compound DCF and NDSF must be greater than the RDS of the transmission fiber to achieve perfect slope compensation. FIG. 10 shows that even though the RDS of the compound DCF and NDSF on the one hand, and the transmission fiber on the other, are approximately equal, the net RDS of the system is still greater than zero. In fact, dispersion slope compensation is most difficult for a link for which the net dispersion of the link is designed to be positive.

It should be noted that the subject invention is also suited to system designs whereby the net dispersion is designed to be zero or negative.

Note that the example link using the teachings of the subject invention described herein is designed within the constraints of the insertion loss budget of a typical line amplifier site. The effect will be improved if a larger insertion loss budget is available at the amplifier sites or if lower insertion loss DCF is available, or both. Also note that if the DCF (in the DSCM) is available with a higher RDS, the performance of the DCF with the NDSF will be improved. Furthermore, if the NDSF (in the DCM) is replaced by a lower RDS fiber (such as Pure Silica Core Fiber with an enlarged effective area) or negative RDS fiber (negative RDS being achieved by positive dispersion and negative dispersion slope) the performance of the DCF with the DCM will be improved. The advantage of a negative RDS DCM in a system is not immediately obvious, according to known systems. Indeed, there is currently no use for a DCM, which has a positive dispersion and a negative dispersion slope, resulting in a negative RDS.

The best results are obtained when the DCF employed has the highest possible RDS, as noted above. When NDSF is employed in the DCM, significant dispersion slope compensation improvement will not result if the RDS of the DCF is less than approximately two times the RDS of NDSF.

The subject invention will work with any type of dispersion compensating device, DCM or DSCM, manufactured using any appropriate technology, such as, but not restricted to, Fiber Bragg Gratings.

The subject invention can be thought of as adding NDSF or other such low RDS (or better still negative RDS) fiber to the system to reduce the net RDS of the transmission fiber. Then, improved dispersion slope compensation for the system can be achieved by using commercially available DCF in the DSCM.

It will be apparent that, optionally, the DSCM could appear ahead of the DCM in the amplifier site of FIG. 5. Further, it will be understood that the dispersion compensation module and the dispersion slope compensation module could be located outside an amplification site and still provide dispersion compensation. Furthermore, the NDSF and DCF could be integrated with and part of the transmission fiber cable.

While the foregoing describes transmission fiber 14 as comprising a TWRS fiber, the invention has application to any transmission fiber with a dispersion slope too steep to be compensated for by a DCF. Examples are LEAF, ELEAF and TrueWave Classic fiber.

Other modifications will be apparent to those skilled in the art and, therefore, the invention is defined in the claims.

What is claimed is:

1. A method for facilitating the reduction of relative dispersion slope (“RDS”) in an optical transmission fiber having a relatively steep RDS, comprising:
passing signals on said optical transmission fiber through a second optical fiber having a less steep RDS.

2. The method of claim 1 wherein said optical transmission fiber has a positive dispersion slope and further comprising:
passing said signals through a third optical fiber having a negative dispersion slope.

3. The method of claim 2 wherein said optical transmission fiber has a positive dispersion, said second optical fiber has a positive dispersion, and said third optical fiber has a negative dispersion.

4. The method of claim 3 wherein said second optical fiber is a non-dispersion shifted fiber (“NDSF”) and wherein said third optical fiber is a dispersion compensating fiber (“DCF”).

5. The method of claim 3 wherein said second optical fiber is a negative relative dispersion slope (RDS) fiber exhibiting positive dispersion and negative dispersion slope and wherein said third optical fiber is a dispersion compensating fiber (“DCF”).

6. The method of claim 3 further comprising amplifying said signals prior to passing said signals through said second optical fiber and said third optical fiber.

7. The method of claim 4 further comprising passing said signals through a sufficient length of said DCF to substantially zero net dispersion of said signals at approximately a centre frequency of said signals.

8. Apparatus for facilitating the reduction of relative dispersion slope (“RDS”) in an optical transmission fiber having a relatively steep RDS, comprising:
a dispersion compensation module (DCM) comprising a second optical fiber having a a less steep RDS.

9. The apparatus of claim 8 further comprising connectors for connecting said DCM in series in said optical transmission line.

10. The apparatus of claim 8 further comprising:
a dispersion slope compensation module (DSCM), comprising a third optical fiber having a negative dispersion slope.

11. The apparatus of claim 10 further comprising connectors for connecting said DSCM in series in said optical transmission line.

12. The apparatus of claim 10 wherein said second optical fiber is a non-dispersion shifted fiber (NDSF) and wherein said third optical fiber is a dispersion compensating fiber (DCF).

13. The apparatus of claim 12 further comprising at least one amplifier for providing gain to said transmission fiber.

14. A method of compensating for dispersion slope in an optical transmission fiber comprising:
passing optical signals on said optical transmission fiber through a length of non-dispersion shifted fiber; and
passing said optical signals through a length of dispersion compensating fiber.

15. A method of compensating for dispersion slope in an optical transmission fiber comprising:
passing optical signals on said optical transmission fiber through a length of a negative relative dispersion slope (RDS) fiber exhibiting positive dispersion and negative dispersion slope; and
passing said optical signals through a length of dispersion compensating fiber.

16. Apparatus for compensating for dispersion slope in an optical transmission fiber comprising:
a first module comprising non-dispersion shifted fiber; and
a second module comprising dispersion compensating fiber,
each said module for serial connection to said optical transmission fiber.

17. Apparatus for compensating for dispersion slope in an optical transmission fiber comprising:
a first module comprising negative relative dispersion slope (RDS) fiber exhibiting positive dispersion and negative dispersion slope; and
a second module comprising dispersion compensating fiber,
each said module for serial connection to said optical transmission fiber.

18. The method of claim 3 wherein said second optical fiber is a Pure Silica Core Fiber with an enlarged effective area and wherein said third optical fiber is a dispersion compensating fiber (DCF).

19. The apparatus of claim 10 wherein said second optical fiber is a Pure Silica Core Fiber with an enlarged effective area and wherein said third optical fiber is a dispersion compensating fiber (DCF).
